(19) United States
(12) Patent Application Publication
(10) Pub. No.: US 2009/0069531 A1
(43) Pub. Date: Mar. 12, 2009

(54) Polyimide Film

(76) Inventors: Hisayasu Kaneshiro, Kyoto (JP); Takashi Kikuchi, Shiga (JP); Takaaki Matsuwaki, Tokyo (JP)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 11/918,181

(22) PCT Filed: Apr. 12, 2006
(86) PCT No.: PCT/JP2006/307755

§ 371 Date: Oct. 9, 2007

(30) Foreign Application Priority Data
Apr. 12, 2005 (JP) 2005-115154

(51) Int. Cl. C08G 73/10

(52) U.S. Cl. 528/322

(57) ABSTRACT

A polyimide film which, when used in FPC production, is reduced in dimensional change during the production steps. In particular, a metal-clad laminate apt to have abnormal parts such as rumples is produced from the film, and an FPC reduced in dimensional change is obtained in high yield. The polyimide film has a tan δ peak temperature within a range of 320° C. or more and lower than 380° C. in measuring a dynamic viscoelasticity, and is characterized by having a maximum sag of 13 mm or less.

### TECHNICAL FIELD

The present invention relates to a non-thermoplastic polyimide film which can be favorably used for a flexible print substrate or a flexible print substrate cover lay film.

### BACKGROUND ART

Recently, with reduction of a weight and a size and enhancement of density of an electronics product, various kinds of print substrates have been demanded. Above all, a flexible printed circuit (referred to also as FPC) has been particularly demanded. The FPC has a structure in which a circuit made of metallic foil is formed on an insulative film.

In producing the FPC, generally, an insulative film constituted of various kinds of insulative materials and having flexibility is used as a substrate, and a metallic foil is combined with a surface of the substrate via various kinds of adhesive materials through heat pressure, thereby producing a flexible metal-clad laminate as the FPC. As the insulative film, it is preferable to use a polyimide film and the like. General examples of the adhesive materials include thermosetting adhesives such as epoxy adhesive, acryl adhesive, and the like (hereinafter, an FPC using these thermosetting adhesives is referred to also as “three-layer FPC”).

Further, in order to satisfy requirements such as higher heat resistance, higher bendability, and higher electric reliability, there is proposed an FPC in which a metal layer is provided directly on an insulative film or thermoplastic polyimide is used for a bonding layer (hereinafter, such an FPC is referred to also as “two-layer FPC”). Both the two-layer FPC and the three-layer FPC have been more and more demanded.

Under such circumstances, a polyimide film used as a base material has been required to have higher functions with a higher yield. Specifically, it is required to produce a polyimide film reduced in dimensional change rate at the time of production thereof in case of using the polyimide film for the FPC, and it is required to obtain the FPC reduced in dimensional change in a high yield. The phrase “to obtain the FPC reduced in dimensional change in a high yield” means the following condition: In case of continuously producing metal-clad laminates used in the FPC production, each metal-clad laminate is less likely to have abnormal parts such as rumples and less dimensional change occurs when the resultant metal-clad laminate is processed into the FPC. Even in case of using a polyimide film reduced in dimensional change, when an unusable part caused by rumples increases in a long metal-clad laminate, the unusable part has to be given up, so that the yield of the FPC decreases, which results in a problem such as the higher cost and the like.

Particularly in view of dimensional stability of the FPC, it is important that a thermal shrinkage of the polyimide film is small (Patent Documents 1 and 2) as well known by person with ordinary skill in the art. However, it is actual that little progress has been made in studying a method for obtaining the FPC reduced in dimensional change in a higher yield. That is, a method for obtaining a metal-clad laminate which has less rumples and is free from any problem in its appearance so that the FPC is obtained in a high yield is studied, or a method for reducing the dimensional change by suitably setting a composition of the polyimide film used for the metal-clad laminate is studied, but little attention has been paid to an yield at the time of continuous production.

Under such circumstances, a trial to improve the productivity by defining a maximum sag has been carried out, but this trial has such a fatal problem that: the improvement is made by carrying out a stretching operation, so that great unevenness occurs in width-direction anisotropy (Patent Document 3). Patent Document 1: Japanese Unexamined Patent Publication No. 77353/1998 (Tokukaihei 10-77353) Patent Document 2: Japanese Unexamined Patent Publication No. 335874/2003 (Tokukai 2003-335874) Patent Document 3: Japanese Unexamined Patent Publication No. 346210/2004 (Tokukai 2004-346210)

### DISCLOSURE OF INVENTION

### Problems to be Solved by the Invention

The present invention was made in view of the foregoing problems, and an object of the present invention is to provide a polyimide film which can be favorably used as a base material of an FPC having been further demanded. Specifically, an object of the present invention is to provide a polyimide film reduced in dimensional change in FPC production steps, and particularly to produce a metal-clad laminate having less abnormal parts such as rumples so as to obtain an FPC reduced in dimensional change in a high yield.

### Means to Solve the Problems

The inventors of the present invention diligently studied in view of the foregoing problems. As a result, they found it possible to obtain a polyimide film which can be favorably used as a substrate of an FPC by designing properties of the polyimide film, thereby completing the present invention.

That is, they found it possible to solve the foregoing problems by the following novel polyimide film of the present invention.

1) A polyimide film having a tan δ peak temperature of 320° C. or higher and lower than 380° C. in measuring a dynamic viscoelasticity, and is characterized by having a maximum sag of 13 mm or less.

2) The polyimide film based on the arrangement described in 1), wherein a tearing strength retention is 60% or more after a PCT treatment.

3) The polyimide film based on the arrangement described in 1) or 2), wherein a maximum value of a tan δ peak is 0.1 or more.

4) The polyimide film based on the arrangement described in 3), wherein the maximum value of the tan δ peak is 0.2 or less.

5) The polyimide film based on any one of the arrangements 1) to 4), wherein an average linear expansion coefficient at 100 to 200° C. ranges from 5 to 20 ppm.

6) The polyimide film based on any one of the arrangements 1) to 5), comprising a polyimide resin obtained by polymerizing acid dianhydried and diamine, wherein the diamine component includes 2,2-bis[4-(4-aminophenoxy)phenyl]propane.

### EFFECTS OF THE INVENTION

If flexible metal-clad laminates are continuously produced by using the polyimide film of the present invention, it s possible to improve the appearance yield of the flexible metal-clad laminate. Further, if an FPC is produced by using the resultant metal-clad laminate, it is possible to suppress occurrence of dimensional change in production steps, and it is further possible to obtain an FPC reduced in dimensional change in a high yield.

### BRIEF DESCRIPTION OF DRAWINGS

FIG. 1 is a cross sectional view of a film sag measurement device.

FIG. 2 is a general view of the film sag measurement device.

FIG. 3 is a cross sectional view taken along A-B line.

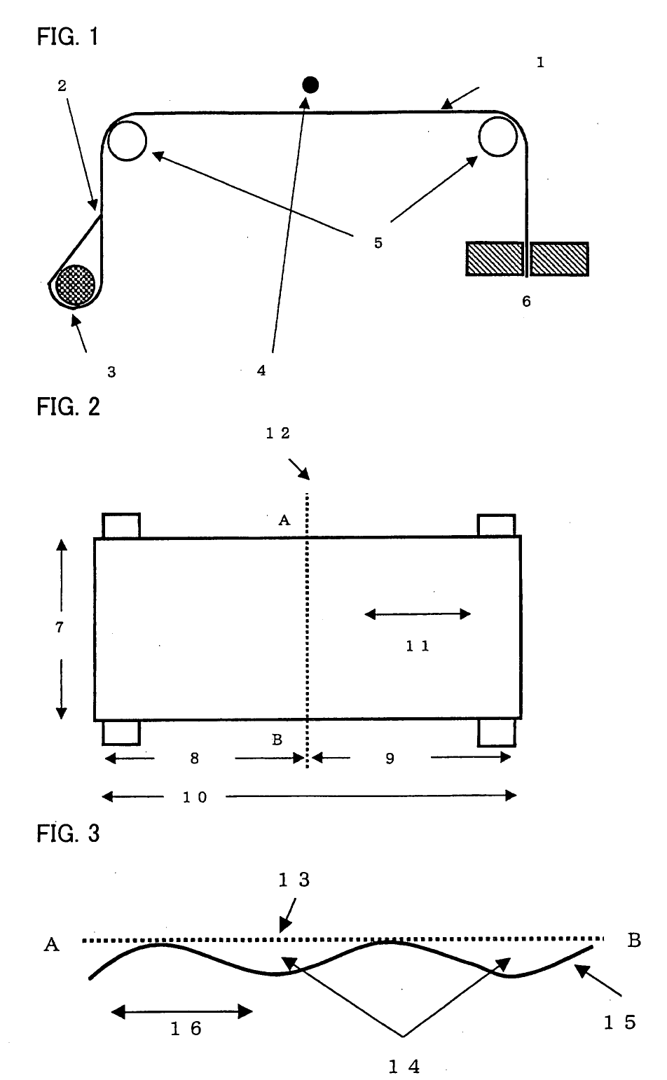

### REFERENCE NUMERALS

1 Film
2 Fixation with a tape or the like
3 Weight 3 kg/m
4 Horizontal baseline (sag measurement point)
5 Support roll
6 Fixation
7 510 mm
8 1.5 m
9 1.5 m
10 3 m
11 Film MD direction
12 Horizontal baseline (sag measurement point)
13 Horizontal baseline (sag measurement point)
14 Sag
15 Film
16 Film TD direction

### BEST MODE FOR CARRYING OUT THE INVENTION

### Properties of a Polyimide Film of the Present Invention

The polyimide film of the present invention has (1) a tan δ peak temperature within a range of 320° C. or higher and lower than 380° C. in measuring a dynamic viscoelasticity, and

(2) a maximum sag of 13 mm or less.

The following describes a dynamic viscoelasticity. If a tan δ peak temperature in measuring the dynamic viscoelasticity is lower than 320° C., a glass transition temperature becomes too low, so that dimensional stability in a heat treatment is impaired. Further, if the tan δ peak temperature is 380° C. or higher, it is impossible to alleviate a strain in processing the polyimide film into an FPC. As a result, the dimensional stability is likely to be impaired. It is preferable that the tan δ peak temperature ranges from 330 to 370° C.

Further, a preferable lower limit of the tan δ peak is 0.05. If the tan δ peak is below this range, it is impossible to alleviate a strain in processing the polyimide film into an FPC. As a result, the dimensional stability is likely to be impaired. The lower limit is more preferably 0.08, and most preferably 0.1. While, a preferable upper limit of the tan δ peak is 0.2. If the tan δ peak is above this range, the film is softened in producing the film, so that this may cause a sag to increase.

Further, it is preferable that a storage elasticity (E′) at a temperature where the tan δ peaks in measuring the dynamic viscoelasticity is 0.4 GPa or more. If the storage elasticity E′ is below this range, the film is softened in producing the film, so that this may cause a sag to increase. The storage elasticity E′ is preferably 0.5 GPa or more, particularly preferably 0.6 GPa or more.

Next, the sag is described as follows. It is general that the polyimide film has a great sag. The great sag may be caused by a high temperature required in sintering the polyimide film or by uneven temperature in a sintering oven. The inventors of the present invention variously studied a conventionally known polyimide film. As a result, they found that the great sag causes appearance of the metal-clad laminate to be impaired which results in a lower yield and lower reliability of the resultant FPC. Further, they found also that the greater sag of the polyimide film causes the dimensional change of the FPC and unevenness thereof to be greater. This may result from FPC production steps. That is, the sag of the polyimide film causes width-direction unevenness of a tension which occurs in the FPC production steps, so that unevenness in the dimensional change accordingly occurs. Thus, in the present invention, the sag of the polyimide film is 13 mm or less, preferably 11 mm or less, particularly 10 mm or less.

Further, it is preferable that a thermal shrinkage of the polyimide film of the present invention is 0.05% or less, further, 0.04% or less. If the thermal shrinkage is above this range, the dimensional stability is likely to be impaired, so that the yield of the FPC is likely to decrease.

### (Preferable Example of Production of the Polyimide Film of the Present Invention)

The following describes an embodiment of the present invention.

The polyimide film used in the present invention can be produced by using a solution containing polyamic acid, and the polyimide film can be produced by adopting a conventionally known method.

As a production method of polyamic acid, it is possible to adopt any known method. Generally, aromatic acid dianhydride and aromatic diamine are dissolved in an organic solvent so that molar amounts thereof are substantially equal to each other, and the resultant polyamic acid organic solvent solution is stirred under a controlled temperature condition until polymerization of acid dianhydride and diamine is completed. A concentration of the polyamic acid solution generally ranges from 5 to 35 wt %, preferably from 10 to 30 wt %. In case where the concentration of the solution is in this range, it is possible to obtain proper molecular weight and solution viscosity.

As a polymerization method, it is possible to adopt any known methods and a combination thereof. The method for polymerizing polyamic acid is characterized by an order in which monomers are added. By controlling the order in which the monomers are added, it is possible to control properties of the resultant polyimide. Thus, in the present invention, it is possible to adopt any method for adding the monomers in polymerizing polyamic acid. Typical polymerization methods are as follows.

1) Aromatic diamine compound is dissolved in an organic polar solvent, and the resultant is reacted with aromatic tetracarboxylic acid dianhydride so that molar amounts thereof are substantially equal to each other.

2) Aromatic tetracarboxylic acid dianhydride and an excessively small molar amount of aromatic diamine compound are reacted in an organic polar solvent so as to obtain a prepolymer having acid anhydride groups in its both ends. Subsequently, the aromatic diamine compound is used so that molar amounts of the aromatic tetracarboxylic acid dianhydride and the aromatic diamine compound used in all the steps are substantially equal to each other so as to carry out polymerization at a single stage or at multiple stages.

3) Aromatic tetracarboxylic acid dianhydride and an excessively large molar amount of aromatic diamine compound are reacted in an organic polar solvent so as to obtain a prepolymer having amino groups in its both ends. Subsequently, after further adding aromatic diamine compound thereto, the aromatic tetracarboxylic acid dianhydride is used so that molar amounts of the aromatic tetracarboxylic acid dianhydride and the aromatic diamine compound used in all the steps are substantially equal to each other so as to carry out polymerization at a single stage or at multiple stages.

4) After dissolving and/or dispersing aromatic tetracarboxylic acid dianhydride in an organic polar solvent, the aromatic diamine compound is used so that molar amounts thereof are substantially equal to each other so as to carry out polymerization.

5) A mixture of aromatic tetracarboxylic acid dianhydride and aromatic diamine whose molar amounts are substantially equal to each other is reacted in an organic polar solvent so as to carry out polymerization.

These methods may be adopted independently or a partial combination thereof may be adopted.

As a method for producing a polyimide film by using the polyamic acid solution, it is possible to adopt a conventionally known method. Examples of the method include thermal imidization and chemical imidization. Any of them may be adopted in producing the film, but the chemical imidization more easily realizes a polyimide film having properties favorably used in the present invention.

Further, a particularly preferable method in the present invention for producing the polyimide film includes the steps of:

a) reacting aromatic diamine and aromatic tetracarboxylic acid dianhydride in an organic solvent so as to obtain a polyamic acid solution;

b) casting a film formation dope containing the polyamic acid solution onto a support body;

c) peeling from the support body a gel film obtained by heating the film formation dope on the support body; and

d) further heating the gel film so as to imidize and dry residual amic acid.

In the aforementioned steps, it is possible to use a curing agent containing a dehydrating agent represented by acid anhydride such as acetic anhydride and an imidization catalyst represented by tertiary amines such as isoquinoline, β-picoline, and pyridine.

The following describes the chemical imidization, a preferable embodiment of the present invention, as an example so as to explain the production steps of the polyimide film. However, the present invention is not limited to the following example.

A film formation condition and a heating condition can vary depending on a kind of polyamic acid, a film thickness and the like.

a) The step of reacting aromatic diamine and aromatic tetracarboxylic acid dianhydride in an organic solvent may be arranged in any manner as long as polyamic acid solution can be obtained in the foregoing manner.

Any acid anhydride may be used as acid anhydride suitable for use in the present invention, but examples thereof include: pyromellitic acid dianhydride, 2,3,6,7-naphthalene tetracarboxylic acid dianhydride, 3,3′,4,4′-biphenyl tetracarboxylic acid dianhydride, 1,2,5,6-naphthalene tetracarboxylic acid dianhydride, 2,2′,3,3′-biphenyl tetracarboxylic acid dianhydride, 3,3′,4,4′-benzophenone tetracarboxylic acid dianhydride, 4,4′-oxydiphthalic acid dianhydride 2,2-bis(3,4-dicarboxyphenyl)propane dianhydride, 3,4,9,10-perylene tetracarboxylic acid dianhydride, bis (3,4-dicarboxyphenyl) propane dianhydride, 1,1-bis (2,3-dicarboxyphenyl)ethane dianhydride, 1,1-bis (3,4-dicarboxyphenyl)ethane dianhydride, bis (2,3-dicarboxyphenyl) methane dianhydride, bis (3,4-dicarboxyphenyl)ethane dianhydride, oxydiphthalic acid dianhydride, bis(3,4-dicarboxyphenyl) sulfone dianhydride, p-phenylene bis(trimellitic acid monoester anhydride), ethylene bis(trimellitic acid monoester anhydride), bisphenol A bis(trimellitic acid monoester anhydride) and analogues thereof. It is preferable to use these acid dianhydrides independently or use a mixture thereof at any mixture ratio. Among them, it is preferable to use at least one kind selected from 3,3′,4,4′-biphenyl tetracarboxylic acid dianhydride, 2,2′,3,3′-biphenyl tetracarboxylic acid dianhydride, 3,3′,4,4′-benzophenone tetracarboxylic acid dianhydride, 4,4′-oxydiphthalic acid dianhydride, and pyromellitic acid dianhydride, because it is possible to easily obtain a desired polyimide film by using such acid dianhydride and it is possible to easily realize necessary properties as a base film of the FPC by using such acid dianhydride.

Examples of diamine favorably usable in the present invention include: p-phenylene diamine, 4,4′-diaminodiphenyl propane, 4,4′-diaminodiphenyl methane, benzidine, 3,3′-dichlorobenzidine, 4,4′-diaminodiphenyl sulfide, 3,3′-diaminodiphenyl sulfone, 4,4′-diaminodiphenyl sulfone, 4,4′-diaminodiphenyl ether, 3,3′-diaminodiphenyl ether, 3,4′-diaminodiphenyl ether, 1,5-diamino naphthalene, 4,4′-diaminodiphenyl diethylsilane, 4,4′-diaminodiphenyl silane, 4,4′-diaminodiphenyl ethylphosphine oxide, 4,4′-diaminodiphenyl N-methylamine, 4,4′-diaminodiphenyl N-phenylamine, 1,4-diamino benzene (p-phenylene diamine), 1,3-diaminobenzene, 1,2-diaminobenzene, 2,2-bis[4-(4-amino phenoxy) phenyl] propane and analogues thereof. Among these diamines, it is preferable to use 2,2-bis[4-(4-amino phenoxy) phenyl] propane because it is possible to easily obtain a desired polyimide film by using such diamine and it is possible to easily realize a low hygroscopic property.

It is preferable that the polyimide film of the present invention has an average linear expansion coefficient of 5 to 20 ppm at 100 to 200° C. because such an average linear expansion coefficient causes the resultant FPC to have favorable dimensional stability. It is preferable to select acid dianhydride or diamine so that the average linear expansion coefficient ranges from 5 to 20 ppm.

Note that, as to selection of acid dianhydride or diamine used in the step a), this is related to the below-described step d) of further heating the gel film so as to imidize and dry residual amic acid. Thus, the step a) will be described at the same time of the step d).

As a solvent favorably used to synthesize a polyimide precursor (hereinafter, referred to as “polyamic acid”), it is possible to use any solvent as long as the solvent can dissolve polyamic acid. It is possible to use an amic solvent, i.e., N,N-dimethylformamide, N,N-dimethylacetamide, N-methyl-2-pyrrolidone, and it is particularly preferable to use N,N-dimethylformamide and N,N-dimethylacetamide.

Also, it is possible to add a filler in order to improve film properties such as a sliding property, a heat conduction property, conductivity, a corona resistance, and loop stiffness. Any material may be used as the filler, but favorable examples thereof include silica, titanium oxide, alumina, silicon nitride, boron nitride, calcium hydrogen phosphate, calcium phosphate, and isinglass.

A particle diameter of the filler is determined depending on a film property to be modified and a type of the filler to be added, so that the particle diameter is not particularly limited. However, an average particle diameter thereof is generally 0.05 to 100 μm, preferably 0.1 to 75 μm, more preferably 0.1 to 50 μm, particularly preferably 0.1 to 25 μm. If the particle diameter is below this range, it is hard to exhibit modification effect. If the particle diameter is above the range, the surface quality may be greatly impaired or the mechanical property may greatly decrease. Further, also an amount of the filler to be added is determined depending on a film property to be modified and a particle diameter of the filler to be added, so that the amount is not particularly limited. With respect to 100 parts by weight of polyimide, the amount of the filler to be added is generally 0.01 to 100 parts by weight, preferably 0.01 to 90 parts by weight, more preferably 0.02 to 80 parts by weight. If the amount is below this range, it is hard to exhibit modification effect. If the amount is above the range, the mechanical property may greatly decrease. Examples of a method for adding the filler are as follows.

1. The filler is added to a polymerization reaction solution before or during polymerization.

2. After completion of the polymerization, the filler is kneaded by using three rolls or the like.

3. A dispersion liquid containing the filler is prepared beforehand, and the dispersion liquid is mixed with the polyamic acid organic solvent solution.

In this way, any method may be used, but it is preferable to adopt the method in which the dispersion liquid containing the filler is mixed with the polyamic acid solvent solution, particularly the method in which the dispersion liquid is mixed with the polyamic acid solvent solution just before the film formation. According to this method, the filler least contaminates the production line. In case of preparing the dispersion liquid containing the filler, it is preferable to use the same solvent as the polyamic acid polymerization solvent. Further, a dispersing agent, a viscosity improver or the like may be used so as to favorably disperse the filler and so as to stabilize the dispersion condition while preventing any influence from being exerted to the film property.

Next, the following describes the step b) of casting a film formation dope containing the polyamic acid solution onto a support body.

The dehydrating agent and the imidization catalyst are mixed in the polyamic acid solution so as to obtain a film formation dope. Subsequently, the film formation dope is cast in a film manner onto the support body such as a glass plate, an aluminum foil, an endless stainless belt, and a stainless drum, and the cast film formation dope is heated on the support body at a temperature range of 80° C. to 200° C., preferably at a temperature range of 100° C. to 180° C., so as to activate the dehydrating agent and the imidization catalyst, thereby partially curing and/or drying the film formation dope. Thereafter, the resultant is peeled from the support body, thereby obtaining a polyamic acid film (hereinafter, referred to as “gel film”).

The gel film is at an intermediate stage of cure of polyamic acid into polyimide and has a self supporting property, and its volatile matter content calculated by the following expression (1) ranges from 5 to 500 wt %, preferably from 5 to 200 wt %, more preferably from 5 to 150 wt %.

(A−B)×100/B (1)

where A represents a weight of the gel film and B represents a weight of the gel film having been heated at 450° C. for 20 minutes.

It is preferable to use the gel film whose volatile matter content is in the aforementioned range. If the volatile matter content deviates from the range, this may result in troubles: such as film breakage in the sintering step; color tone unevenness which occurs in the film due to an uneven drying treatment; occurrence of anisotropy; property unevenness; and the like.

With respect to 1 mol of an amic acid unit contained in polyamic acid, an amount of the dehydrating agent preferably ranges from 0.5 to 5 mol, more preferably from 1.0 to 4.0 mol.

Further, with respect to 1 mol of an amic acid unit contained in polyamic acid, an amount of the imidization catalyst preferably ranges from 0.05 to 3 mol, more preferably from 0.2 to 2 mol.

If the amount of the dehydrating agent and the amount of the imidization catalyst are respectively below the aforementioned ranges, chemical imidization is not sufficiently carried out, so that the insufficient chemical imidization may result in breakage during the sintering treatment and lower mechanical strength. Further, if these amounts are above the aforementioned ranges respectively, the imidization is accelerated too fast, so that it may be difficult to cast the film formation dope in a film manner.

Next, there is carried out the step c) of peeling from the support body a gel film obtained by heating the film formation dope on the support body, thereby obtaining the gel film.

Next, the following describes the step d) of further heating the gel film so as to imidize and dry residual amic acid. As the step d), it is preferable to adopt the step in which: the gel film obtained in the step c) is dried with its end fixed so that shrinkage at the time of the curing treatment is prevented, so as to remove water, residual solvent, residual imidization catalyst, and residual dehydrating agent, thereby completely imidizing residual amic acid. In the step d), a known heating oven such as a hot-air dry oven and a far-infrared-ray dry oven is used.

As described above, the inventors of the present invention think that a maximum sag of the polyimide film is caused by a sintering condition thereof. According to the study carried out by the inventors, it was found that it is possible to obtain the desired polyimide film by selecting or combining the following methods (1) to (3) in order to suppress the sag into a specific range.

(1) A temperature in the heating oven is gradually increased.

(2) Width-direction temperature unevenness in the heating oven is reduced.

(3) A final sintering temperature is suppressed at a low temperature.

If one of these methods is carried out, it is possible to obtain some effects, but it is preferable to combine the methods with one another.

Out of these methods, the methods (1) and (2) can be achieved by facility design. For example, as to the method (1), in case of using a plurality of ovens which are coupled to each other, it is preferable to reduce a temperature difference therebetween. It is preferable that the temperature difference is 150° C. or lower, further, 120° C. or lower. Further, as to the method (2), it is preferable to suppress the width-direction temperature unevenness in the heating oven to 60° C. or lower, further, 50° C. or lower, particularly, 30° C. or lower.

Further, as to the final sintering temperature of the method (3), it is preferable to heat the film at a temperature ranging from 400 to 500° C. for 5 to 400 seconds. If the maximum sintering temperature is set to be within the aforementioned range, it is likely to be possible to easily set the sag of the film to 13 mm or less, preferably 11 mm or less, particularly preferably 9 mm or less. Within the aforementioned range, the heating time is controlled so that the heating time is longer when the temperature is lower and the heating time is shorter when the temperature is higher as commonly conceived by person with ordinary skill in the art.

At this time, it is possible to adopt not only the hot-air drying treatment but also any known heating means such as a far infrared ray heater and a microwave heater. The final sintering temperature (temperature in the vicinity of the film) preferably ranges from 400 to 480° C., particularly preferably from 400 to 460° C. If the temperature is too low, the film is not sufficiently dried and imidized, which may result in lower reliability as the FPC under a harsh condition. If the temperature is too high, the sag of the film is likely to increase.

Also, it is possible to heat the film with a minimum tension required in carrying the film so as to alleviate an internal stress remaining in the film. This heat treatment may be carried out in the film production steps or may be carried out in an additional step. The heating condition cannot be uniformly determined because the heating condition varies depending on a film property and a device used therein. However, the heat treatment is carried out generally at 200° C. or higher 500° C. or lower, preferably at 250° C. or higher 500° C. or lower, particularly preferably 300° C. or higher 450° C. or lower for 1 to 300 seconds, preferably 2 to 250 seconds, particularly preferably 5 to 200 seconds, thereby alleviating the internal stress and decreasing the thermal shrinkage at 200° C.

Further, it is possible to stretch the gel film before and after fixing the gel film while preventing deterioration of the anisotropy. At this time, the volatile matter content preferably ranges from 100 to 500 wt %, more preferably from 150 to 500 wt %. If the volatile matter content is below this range, it is likely to be hard to stretch the gel film. If the volatile matter content is above the range, the self supporting property of the gel film is not sufficient, so that it is likely to be hard to carry out the stretching operation.

In stretching the gel film, it is possible to adopt any known method such as a method using a differential roll and a method in which fixation intervals of stenters are increased.

In case of adopting the method (3) in which the final sintering temperature is suppressed at a low temperature, the final sintering temperature of the polyimide film is greatly limited by a molecular structure of polyimide, so that it is possible to sinter the polyimide film at a low temperature by appropriately designing the molecule of polyimide.

A relation between the maximum sintering temperature and the molecular structure of polyimide is as follows.

In sintering the polyamic acid film (gel film) having been partially dried and/or imidized, some structures allow smooth acceleration of imidization and other structures do not allow smooth acceleration of imidization depending on a molecular structure of polyamic acid (or polyimide) even when the same sintering temperature is adopted thereto.

While, in order to realize favorable adhesiveness and anti-PCT property (retention of the adhesiveness after the PCT treatment) of the resultant polyimide film, it is necessary to sufficiently carry out imidization of the film. Specifically, it is necessary to sinter the film at a temperature required in sufficiently carrying out the imidization. However, as the sintering temperature is higher, the sag of the film is greater.

It is desirable to sinter the film at a temperature which does not allow the sag of the film to increase, but a well-known polyimide film is sintered at a high temperature in order to improve the property such as the adhesiveness. That is, if the well-known polyimide film is sintered at a low temperature in order to obtain a polyimide film whose sag is small, the resultant polyimide film is likely to have insufficient adhesiveness and the anti-PCT property. This discouraged person with ordinary skill in the art from setting the maximum sintering temperature in the production steps of the polyimide film at a lower temperature.

However, the inventors of the present invention found that: even if the maximum sintering temperature is suppressed at a low temperature, it is possible to sufficiently accelerate the imidization by appropriately designing the molecular structure of polyimide, so that it is possible to obtain the polyimide film whose sag is not increased and which has excellent adhesiveness and anti-PCT property.

Further, the inventors of the present invention variously studied the molecular design of the polyimide film. As a result, they found that the molecule can be highly freely designed and not only the aforementioned properties but also dimensional stability can be taken into consideration. That is, they found it effective in obtaining the polyimide film whose dimensional stability is high to set the tan δ peak temperature of the resultant polyimide film to 320° C. or higher and lower than 380° C. as long as the molecular design allows the low temperature sintering operation.

An example of the molecular design is described as follows.

In order to lower the final sintering temperature, it is necessary to use polyimide having a tan δ peak. If trials are repeated on the basis of the following standards, a person with ordinary skill in the art can easily carry out the molecular design.

I) An amount of diamine having a rigid structure, e.g., paraphenylenediamine, benzidine derivative, and the like is increased, so that the tan δ peak becomes higher and/or the tan δ peak becomes unclear so as to disappear and/or the tan δ value decreases.

An example of diamine having the rigid structure is diamine expressed by the following formula (1),

NH₂—R₂—NH₂ General Formula (1)

where R₂ represents a group selected from bivalent aromatic groups each of which is represented by the following formula,

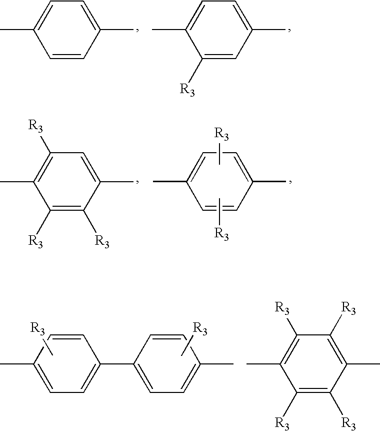

where R₃ represents a group selected from CH₃—, —OH, —CF₃, —SO₄, —COOH, —CO—NH₂, Cl—, Br—, F—, and CH₃O— so that R₃ is identical to or different from other R₃.

II) In case where an amount of diamine having in its molecular chain a flection structure, e.g., an ether group, a carbonyl group, an ester group, a sulfone group, an aliphatic group, and the like, the tan δ peak temperature becomes lower and/or the tan δ peak becomes clear and/or the tan δ value increases.

An example of diamine having the flection structure is diamine represented by the following formula,

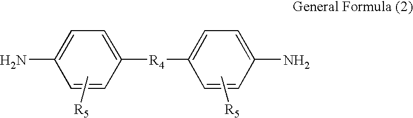

where R₄ represents a group selected from bivalent organic groups each of which is represented by the following formula,

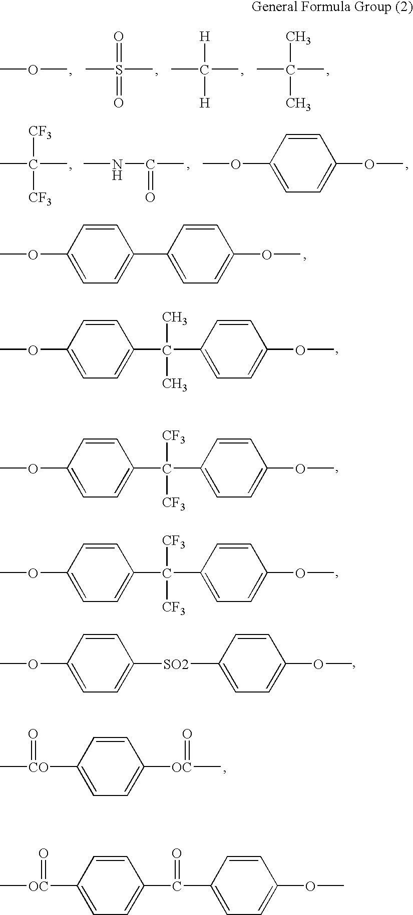

where R₅ represents a group selected from CH₃—, —OH, —CF₃, —SO₄, —COOH, —CO—NH₂, Cl—, Br—, F—, and CH₃O— so that R₅ is identical to or different from other R₅.

III) In case where an amount of acid dianhydride having the rigid structure, e.g., pyromellitic acid dianhydride is increased, the tan δ peak becomes higher and/or the tan δ peak becomes unclear so as to disappear and/or the tan δ value decreases.

IV) In case where an amount of acid dianhydride having the flection structure, e.g., 3,3′-4,4′-biphenyltetracarboxylic acid dianhydride, 3,3′,4,4′-benzophenonetetracarboxylic acid dianhydride, 4,4′-oxydiphthalic acid dianhydride is increased, the tan δ peak temperature becomes lower and/or the tan δ peak becomes clear and/or the tan δ value increases.

Further, as to a composition of the polyimide film whose maximum sag is effectively suppressed by the method (3) in which the final sintering temperature is suppressed at a low temperature, an example thereof is a polyimide film containing non-thermoplastic resin having a block component derived from thermoplastic polyimide. That is, an ideal polyimide film in the present invention is non-thermoplastic as an entire polyimide resin, and its polyimide resin has specific block components therein. Further, each of the specific block components exhibits a thermoplastic property in case where a polyimide film made only of the block components is produced.

An example of a method for polymerizing polyamic acid so as to obtain such a polyimide resin is as follows: In producing a prepolymer in accordance with the aforementioned method 2) or 3) described as the polymerization method of polyamic acid, the prepolymer is produced by setting the composition so as to be thermoplastic polyimide in case where aromatic tetracarboxylic acid dianhydride and aromatic diamine compound are reacted so that molar amounts thereof are equal to each other, and aromatic tetracarboxylic acid dianhydride and aromatic diamine compound used in all the production steps are selected so that the resultant polyimide becomes non-thermoplastic.

For example, 2,2-bis[4-(4-aminophenoxy)phenyl]propane (BAPP) and 4,4′-diaminodiphenylether(4,4′-ODA) are dissolved in DMF (N,N-dimethylformamide), and 3,3′,4,4′-benzophenonetetracarboxylic acid dianhydride (BTDA) is added thereto, and pyromellitic acid dianhydride (PMDA) is added thereto. At this time, BTDA and PMDA are added so that a total amount thereof is excessively small with respect to a total amount of BAPP and 4,4′-ODA, so as to synthesize the thermoplastic polyimide block component. Thereafter, paraphenylenediamine is dissolved in the solution, and pyromellitic acid dianhydride is added so that molar amounts of acid dianhydride and diamine used in all the production steps are equal to each other, thereby obtaining a polyamic acid solution.

Herein, the thermoplastic polyimide block component refers to a component under the following condition: a polyimide resin film (for convenience in description, the film is a polyimide film made of thermoplastic polyimide block component) obtained by reacting aromatic tetracarboxylic acid dianhydride and aromatic diamine compound constituting the block component so that molar amounts thereof are equal to each other is softened in being fixed on a metallic fixation frame and being heated at 450° C. for one minute, and the film is so soft that its original shape is not kept. The polyimide film made of thermoplastic polyimide block component can be obtained by a known method and by carrying out the sintering treatment at the maximum sintering temperature of 300° C. for 15 minutes. A specific example of the production method is as follows: as in the aforementioned method in which whether the block component derived from the thermoplastic polyimide is included or not is confirmed, the sintering treatment is carried out except that the maximum sintering temperature is 300° C. and the sintering time is 15 minutes. In determining the thermoplastic block component, the film is produced in the aforementioned manner and a melting temperature thereof is confirmed.

As the thermoplastic block component, it is preferable to use a polyimide film which is made of the thermoplastic polyimide block component produced in the aforementioned manner and becomes so soft that its original shape cannot be kept in the heat treatment at 250 to 450° C., and it is particularly preferable to use a polyimide film which is made of the thermoplastic polyimide block component produced in the aforementioned manner and becomes so soft that its original shape cannot be kept in the heat treatment at 300 to 400° C. If the temperature is too low, it is difficult to finally obtain the non-thermoplastic polyimide film. If the temperature is too high, it is likely to be hard to obtain the desired film.

Further, with respect to the entire amount of polyimide, the amount of the thermoplastic polyimide block component is preferably 20 to 60 mol %, more preferably 25 to 55 mol %, particularly preferably 30 to 50 mol %.

If the amount of the thermoplastic polyimide block component is below this range, it may be hard to obtain the desired film. If the amount of the thermoplastic polyimide block component is above the range, it is hard to finally obtain the non-thermoplastic polyimide film.

For example, in case where the aforementioned polymerization method 2) is adopted, the amount of the thermoplastic polyimide block component is calculated in accordance with the following expression (1).

(Amount of thermoplastic block component)=a/Q×100 (1)

a: Amount (mol) of acid dianhydride component used in producing the thermoplastic polyimide block component

Q: Amount (mol) of entire acid dianhydride component

Further, in case where the aforementioned polymerization method 3) is adopted, the amount of the thermoplastic polyimide block component is calculated in accordance with the following expression (2).

(Amount of thermoplastic block component)=b/P×100 (2)

b: Amount (mol) of diamine component used in producing the thermoplastic polyimide block component

P: Amount (mol) of entire diamine

In case where the polyimide film made of the thermoplastic polyimide block component is produced in the aforementioned manner, it is preferable that the thermoplastic polyimide block component of the present invention has a glass transition temperature (Tg) in a range of 150 to 300° C. Note that, Tg can be calculated from a value indicative of an inflection point of a storage elasticity measured by a dynamic viscoelasticity measuring apparatus (DMA) or from a similar value.

This method is characterized as follows: First, the thermoplastic polyimide block component is synthesized, and then (i) the thermoplastic polyimide precursor and (ii) remaining diamine and acid dianhydride are reacted, thereby producing the non-thermoplastic polyimide precursor. The thermoplastic polyimide block component and the non-thermoplastic polyimide precursor can be produced by appropriately setting a combination of diamine and acid dianhydride.

As diamine and acid dianhydride combined with the thermoplastic polyimide block component, it is preferable to use as a main component the rigid diamine component which is represented by the aforementioned General Formula (1) and pyromellitic acid dianhydride. By using diamine having the rigid structure, it is more easy to realize the non-thermoplastic property and a high elasticity. Further, as well known, pyromellitic acid dianhydride is likely to allow for the non-thermoplastic polyimide due to its rigid structure. In this manner, the molecular design is carried out so that the resultant polyimide film is non-thermoplastic.

Unlike the foregoing method, it is possible to adopt the following method: First, diamine and acid dianhydride having the rigid structure are used to synthesize the block component having the rigid structure, and then the block component having the rigid structure are suitably combined with flexible diamine represented by the aforementioned General Formula (2) or with acid dianhydride having the flection structure, e.g., 3,3′,4,4′-biphenyltetracarboxylic acid dianhydride, 3,3′,4,4′-benzophenonetetracarboxylic acid dianhydride, 4,4′-oxydiphthalic acid dianhydride, and a mixture thereof is polymerized, thereby realizing the non-thermoplastic property of the resultant film and polymerizing the non-thermoplastic polyimide precursor having the tan δ peak. However, it is more preferable to adopt the method in which the thermoplastic polyimide component is first produced. This realizes excellent stability in polymerizing polyamic acid, so that it is possible to easily obtain the desired polyimide film.

Note that, whether the resultant polyimide film is non-thermoplastic or not is determined as follows. In fixing the polyimide film on a metallic fixation frame and heating the film at 450° C. for one minute, a film keeping its original shape (free from any sag or melting) is determined as being “non-thermoplastic”.

A linear expansion coefficient of the non-thermoplastic polyimide film of the present invention is preferably 5 to 20 ppm. Further, its moisture absorption expansion coefficient is preferably 13 ppm or less.

Further, its elasticity is preferably 5 to 10 GPa.

Generally, these properties can be varied by varying the composition, but these properties can be controlled by changing a process in which the thermoplastic block component of the present invention is selected.

Further, in the present invention, it is essential that the tan δ peak in the dynamic viscoelasticity of the polyimide film is 320° C. or higher and lower than 380° C. An example of a method for obtaining such a film is a method in which the tan δ is controlled in accordance with the aforementioned standards I) to IV). Further, in some compositions, the value of the tan δ peak may vary depending on “which imidization method is selected” (the thermal imidization or the chemical imidization) and an amount of the curing agent, so that the desired tan δ peak is realized by suitably combining these methods.

A flexible metal-clad laminate obtained by using the polyimide film obtained in this manner is reduced in dimensional change, so that it is possible to obtain the flexible metal-clad laminate reduced in dimensional change in a high yield. Further, the resultant flexible metal-clad laminate has excellent appearance, so that it is possible to increase the appearance yield. Further, it is possible to realize the film tearing strength retention of 60% or more after the PCT treatment, so that its reliability is excellent. The film tearing strength retention after the PCT treatment is a retention of the tearing strength after the film has been left at a temperature of 150° C. with a humidity of 100% RH for 12 hours. In the present invention, the film tearing strength retention after the PCT treatment is 60% or more, preferably 70% or more.

### EXAMPLES

The film of the present invention was evaluated as follows.

(Film Tearing Strength Retention after the PCT Treatment)

The film tearing strength retention was measured after the PCT treatment in accordance with ASTM D1938.

Note that, the PCT treatment was carried out at 150° C. with a humidity of 100% RH for 12 hours.

### (Sag)

The film was suspended by two support rolls at an interval of 3 m, and one end of the film was fixed and a load of 3 kg/m was exerted to the other end, and a sag from a horizontal baseline in a width direction (TD) was read. Note that, in measuring the sag, a line which was in contact with a highest position of the film in the TD direction as illustrated in FIG. 3 was regarded as the horizontal baseline. The sag was measured at intervals of 50 mm from a film end, and a maximum value thereof was read.

### (Measurement of Dynamic Viscoelasticity)

The dynamic viscoelasticity was measured by using DMS200 (product of Seiko Instruments Inc.) (sample size: its width was 9 mm and its length was 40 mm) at a temperature ranging from 20 to 400° C. with frequencies 1, 5, and 10 Hz, at a temperature raising rate of 3° C./min. A temperature corresponding to an inflection point of a curve obtained by plotting storage elasticity with respect to the aforementioned temperature was regarded as a glass transition temperature.

### (Linear Expansion Coefficient)

The linear expansion coefficient at 100 to 200° C. was measured by using TMA120C (product of Seiko Instruments Inc.) (sample size: its width was 3 mm and its length was 10 mm). The film was heated from 10° C. to 400° C. with a load of 3 g at 10° C./min, and then the film was cooled down to 10° C., and the film was further heated at 10° C./min, and an average was calculated from the thermal expansion coefficient at 100 to 200° C. at the time of the second heating operation.

### (Thermal Shrinkage)

Based on IPC-TM-650 2.2.4 Method A, the thermal shrinkage was calculated from dimensional change in the heat treatment carried out at 200° C. for two hours. Note that, the thermal shrinkage was measured at two positions: a position in which the sag is maximum in the width direction and a position in which the sag is minimum in the width direction.

### (Determination of Appearance and FPC Processability)

The resultant polyimide film was treated with a corona density of 200 W·min/m², and then the polyimide film was combined with a B-stage-adhesive PET film obtained on the basis of Referential Example, and the resultant was subjected to pressure bonding at 90° C. with a pressure of 1 kg/cm². The PET film was peeled, and a laminate constituted of the polyimide film and the adhesive was continuously combined with a roller round copper foil whose thickness was 12 μm at 120° C. with a pressure of 2 kg/cm in accordance with a roll laminate method. The copper-clad product was gradually heated at 60° C. for three hours, at 80° C. for three hours, at 120° C. for three hours, at 140° C. for three hours, and at 160° C. for four hours, and then is slowly cooled so as to cure the adhesive, thereby obtaining a flexible copper-clad laminate. Its appearance was evaluated in accordance with whether the metal-clad laminate is curled or not. Further, the processability of the FPC was evaluated in accordance with whether any rumples occur or not in laminating the copper foil. As more rumples occur, less parts of the FPC can be processed, so that this is determined as “low processability”.

### Referential Example 1

### Synthesis of Nylon Denaturalized Epoxy Adhesive

45 parts by weight of diaminodiphenyl sulfone/dicyandiamide 4/1 20% methyle cellosolve solution was mixed with a solution obtained by mixing 50 parts by weight of polyamide resin (Platabond M1276 produced by Japan Rilsan Co.), 30 parts by weight of bisphenol A epoxy resin (EPICOTE 823 produced by Yuka-Shell Epoxy Co. Ltd.), 10 parts by weight of cresol novolak epoxy resin, and 150 parts by weight of toluene/isopropylalcohol 1/1 mixture solution, thereby preparing an adhesive solution. The adhesive was applied to a PFT film whose thickness was 25 μm so that the thickness of the adhesive after being dried was 11 μm, and the adhesive was dried at 120° C. for two minutes, thereby obtaining a B-stage adhesive on a support body.

### (Evaluation of Thermoplasticity)

A polyimide film made of thermoplastic polyimide block component was produced by carrying out a sintering treatment at a maximum sintering temperature of 300° C. for a sintering time of 15 minutes. Then, the polyimide film was softened in being fixed on a metallic fixation frame and heated at 450° C. for one minute. If the polyimide film did not keep its original shape, the polyimide film was determined as “thermoplastic”.

### Example 1

25 mol of 2,2-bis[4-(4-aminophenoxy)phenyl]propane(BAPP) and 25 mol of 4,4′-diaminodiphenyl ether(4,4′-ODA) were dissolved in N,N-dimethylformamide (DMF) having been cooled down to 10° C. Then, 30 mol of 3,3′,4,4′-biphenyltetracarboxylic acid dianhydride (BPDA) was added to the resultant so as to be dissolved. Thereafter, 15 mol of pyromellitic acid dianhydride was added to the resultant and was stirred for one hour, thereby forming a thermoplastic polyimide precursor block component. 50 mol of paraphenylenediamine (p-PDA) was dissolved in the solution, and then 53 mol of pyromellitic acid dianhydride (PMDA) was added to the resultant and was stirred for one hour so as to be dissolved. Further, a DMF solution additionally prepared beforehand by adding PMDA was carefully added to the resultant, and the addition was stopped when its viscosity attained 2200 poise (23° C.). The resultant was stirred for one hour, thereby obtaining a polyamic acid solution (its solid concentration was 18 wt % and its viscosity was 2750 poise (23° C.)). During the reaction, a temperature in the system was kept at 20° C.

A curing agent obtained by mixing isoquinoline, acetic anhydride, and DMF whose weight ratio of 7.1/19.0/44.0 with the foregoing polyamic acid solution was quickly stirred by a mixer at a ratio of 60 parts by weight of the curing agent with respect to 100 parts by weight of the polyamic acid, extruded from a T die with its width of 1200 mm, and then cast onto a stainless endless belt moving 15-mm below the die at a speed of 12 m/minute. The resin film was dried at 105° C. for 100 seconds, and then the resultant gel film having self-supporting property was peeled off. At this time, its volatile matter content was 47%. Both ends of the gel film were fixed on stenter pins, and the gel film was dried at 250° C. for 15 seconds (first oven: hot air convection), at 350° C. for 15 seconds (second oven: hot air convection), at 450° C. for 15 seconds (third oven: hot air convection), and at 450° C. for 30 seconds (fourth oven: far infrared ray) so as to be imidized, thereby obtaining a polyimide film whose thickness was 12.5 μm. The film was slit so that its width was 1028 mm, and the slit film was heated in an oven whose temperature was 300° C. with a tension of 3 kg/m for 30 seconds. Properties of the resultant film are shown in Table 1. Temperature unevenness in a width direction of the first oven was 25° C., and temperature unevenness in a width direction of the second oven was 20° C., and temperature unevenness in a width direction of the third oven was 45° C., and temperature unevenness in a width direction of the fourth oven was 55° C., and temperature unevenness in a width direction of the oven in the heating step at 300° C. was 20° C. The temperature unevenness in the width direction was calculated by measuring atmospheric temperatures in three points, i.e., both ends and a central point of the oven.

Note that, the polyamic acid solution obtained so that a ratio of BAPP, 4,4′-ODA, BTDA, and PMDA was 25/25/30/15 was cast on a glass plate, and was sintered at a maximum sintering temperature of 300° C. for 15 minutes, thereby producing a film. The film was fixed on a metallic fixation frame so as to be heated at 450° C., but the film was melted so that the film did not keep its original shape. In this manner, its thermoplastic block component was confirmed.

### Example 2

The same operation as in Example 1 was carried out except that the heat treatment in the fourth oven was carried out at 490° C. for 10 seconds and the temperature unevenness in the width direction of the fourth oven was 45° C., thereby obtaining a polyimide film whose width was 1028 mm. Properties of the resultant film are shown in Table 1.

### Example 3

35 mol of BAPP and 15 mol of 4,4′-ODA were dissolved in N,N-dimethylformamide (DMF) having been cooled down to 10° C. 25 mol of BTDA was added and dissolved therein, and then 20 mol of pyromellitic acid dianhydride was added to the resultant and was stirred for one hour, thereby forming a thermoplastic polyimide precursor block component.

50 mol of paraphenylenediamine (p-PDA) was dissolved in the resultant solution, and then 53 mol of pyromellitic acid dianhydride was added to the resultant and stirred for one hour so as to be dissolved. Further, a DMF solution additionally prepared beforehand by adding PMDA was carefully added to the resultant, and the addition was stopped when its viscosity attained 2200 poise (23° C.). The resultant was stirred for one hour, thereby obtaining a polyamic acid solution (its solid concentration was 18 wt % and its viscosity was 2750 poise (23° C.)). During the reaction, a temperature in the system was kept at 20° C. In the subsequent steps, the same operation as in Example 1 was carried out, thereby obtaining a polyimide film whose width was 1028 mm. Properties of the resultant film are shown in Table 1.

Note that, the polyamic acid solution obtained so that a ratio of BAPP, 4,4′-ODA, BTDA, and PMDA was 35/15/25/25 was cast on a glass plate, and was sintered at a maximum sintering temperature of 300° C. for 15 minutes, thereby producing a film. The film was fixed on a metallic fixation frame so as to be heated at 450° C., but the film was melted so that the film did not keep its original shape. In this manner, its thermoplastic block component was confirmed.

### Example 4

50 mol of PDA was dissolved in N,N-dimethylformamide (DMF) having been cooled down to 10° C. 45 mol of PMDA was added and stirred for one hour.

50 mol of BAPP was dissolved in the resultant solution, and then 20 mol of BTDA was added to the resultant and 33 mol of pyromellitic acid dianhydride (PMDA) was subsequently added thereto, and the resultant was stirred for one hour so as to be dissolved. Further, a DMF solution additionally prepared beforehand by adding PMDA was carefully added to the resultant, and the addition was stopped when its viscosity attained 2200 poise (23° C.). The resultant was stirred for one hour, thereby obtaining a polyamic acid solution (its solid concentration was 18 wt % and its viscosity was 2900 poise (23° C.)). During the reaction, a temperature in the system was kept at 20° C. In the subsequent steps, the same operation as in Example 1 was carried out, thereby obtaining a polyimide film whose width was 1028 mm. Properties of the resultant film are shown in Table 1.

### Example 5

60 mol of PDA was dissolved in N,N-dimethylformamide (DMF) having been cooled down to 10° C. 54 mol of PMDA was added and stirred for one hour.

40 mol of BAPP was dissolved in the resultant solution, and then 10 mol of BTDA was added to the resultant and 34 mol of pyromellitic acid dianhydride (PMDA) was subsequently added thereto, and the resultant was stirred for one hour so as to be dissolved. Further, a DMF solution additionally prepared beforehand by adding PMDA was carefully added to the resultant, and the addition was stopped when its viscosity attained 2200 poise (23° C.). The resultant was stirred for one hour, thereby obtaining a polyamic acid solution (its solid concentration was 18 wt % and its viscosity was 3000 poise (23° C.)). During the reaction, a temperature in the system was kept at 20° C. In the subsequent steps, the same operation as in Example 1 was carried out, thereby obtaining a polyimide film whose width was 1028 mm. Properties of the resultant film are shown in Table 1.

### Comparative Example 1

100 mol of 4,4′-ODA was dissolved in N,N-dimethylformamide (DMF) having been cooled down to 10° C. 96 mol of pyromellitic acid dianhydride (PMDA) was added thereto, and the resultant was stirred for one hour so as to be dissolved. Further, a DMF solution additionally prepared beforehand by adding PMDA was carefully added to the resultant, and the addition was stopped when its viscosity attained 2200 poise (23° C.). The resultant was stirred for one hour, thereby obtaining a polyamic acid solution (its solid concentration was 18 wt % and its viscosity was 2950 poise (23° C.)). During the reaction, a temperature in the system was kept at 20° C. In the subsequent steps, the same operation as in Example 1 was carried out, thereby obtaining a polyimide film whose width was 1028 mm. Properties of the resultant film are shown in Table 1.

### Comparative Example 2

The same operation as in Example 1 was carried out except that the heat treatment in the fourth oven was carried out at 490° C. for 10 seconds and the temperature unevenness of the fourth oven was 70° C., thereby obtaining a polyimide film. Properties of the resultant film are shown in Table 1.

### Comparative Example 3

50 mol of ODA and 50 mol of PDA were dissolved in N,N-dimethylformamide (DMF) having been cooled down to 10° C. 50 mol of TMHQ was added and dissolved therein, and then was stirred for one hour. 47 mol of pyromellitic acid dianhydride (PMDA) was added thereto, and the resultant was stirred for one hour so as to be dissolved. Further, a DMF solution additionally prepared beforehand by adding PMDA was carefully added to the resultant, and the addition was stopped when its viscosity attained 2200 poise (23° C.). The resultant was stirred for one hour, thereby obtaining a polyamic acid solution (its solid concentration was 18 wt % and its viscosity was 2600 poise (23° C.)). During the reaction, a temperature in the system was kept at 20° C. In the subsequent steps, the same operation as in Example 1 was carried out except that the heat treatment in the fourth oven was carried out at 500° C. for 15 seconds and the temperature unevenness in the width direction of the fourth oven was 50° C., thereby obtaining a polyimide film whose width was 1028 mm. Properties of the resultant film are shown in Table 1.

### Comparative Example 4

55 mol of PDA was dissolved in N,N-dimethylformamide (DMF) having been cooled down to 10° C., and 49.5 mol of PMDA was added thereto, and the resultant was stirred for one hour.

45 mol of BAPP was dissolved in the resultant solution, and 47.5 mol of pyromellitic acid dianhydride (PMDA) was added thereto, and the resultant was stirred for one hour so as to be dissolved. Further, a DMF solution additionally prepared beforehand by adding PMDA was carefully added to the resultant, and the addition was stopped when its viscosity attained 2200 poise (23° C.). The resultant was stirred for one hour, thereby obtaining a polyamic acid solution (its solid concentration was 18 wt % and its viscosity was 2900 poise (23° C.)). During the reaction, a temperature in the system was kept at 20° C. In the subsequent steps, the same operation as in Example 1 was carried out except that the heat treatment in the fourth oven was carried out at 480° C. for 15 seconds and the temperature unevenness in the width direction of the fourth oven was 75° C., thereby obtaining a polyimide film whose width was 1028 mm. Properties of the resultant film are shown in Table 1.

TABLE 1

| | | | | | | Thermal shrinkage % | | | | | |
|---|---|---|---|---|---|---|---|---|---|---|---|
| | Linear | | | Tearing | | Maximum | | Maximum | | | |
| | Expansion | | | strength | | sag | | sag | | | |
| | Coefficient | | tan δ peak | retention | Maximum | position | | position | | CCL | CCL |
| | ppm | tan δ | temperature | after PCT | sag mm | MD | TD | MD | TD | processability | appearance |
| Example 1 | 15 | 0.163 | 330° C. | 94% | 4 | 0.03 | 0.01 | 0.04 | 0.01 | ∘ | ∘ |
| Example 2 | 15 | 0.163 | 330° C. | 95% | 13 | 0.04 | 0.01 | 0.02 | 0.00 | ∘ | ∘ |
| Example 3 | 12 | 0.129 | 362° C. | 93% | 3 | 0.04 | 0.00 | 0.03 | 0.00 | ∘ | ∘ |
| (2) | | | | | | | | | | | |
| Example 4 | 17 | 0.161 | 320° C. | 92% | 8 | 0.03 | 0.01 | 0.02 | 0.00 | ∘ | ∘ |
| Example 5 | 12 | 0.134 | 370° C. | 98% | 5 | 0.04 | 0.02 | 0.03 | 0.01 | ∘ | ∘ |
| Comparative | 32 | — | >400° C. | 35% | 5 | 0.15 | 0.02 | 0.12 | 0.00 | ∘ | x |
| Example 1 | | | | | | | | | | | |
| Comparative | 15 | 0.129 | 363° C. | 92% | 14 | 0.03 | 0.01 | 0.08 | −0.02 | x | x |
| Example 2 | | | | | | | | | | | |
| Comparative | 15 | 0.143 | 310° C. | 80% | 15 | 0.04 | 0.01 | 0.03 | 0.01 | x | ∘ |
| Example 3 | | | | | | | | | | | |
| Comparative | 14 | 0.133 | 395° C. | 60% | 14 | 0.07 | 0.03 | 0.05 | 0.02 | x | ∘ |
| Example 4 | | | | | | | | | | | |

1. A polyimide film, having a tan δ peak temperature within a range of 320° C. or higher and lower than 380° C. in measuring a dynamic viscoelasticity, wherein a maximum sag of the polyimide film is less than 13 mm.

2. The polyimide film as set forth in claim 1, wherein a tearing strength retention after a PCT treatment is 60% or more.

3. The polyimide film as set forth in claim 1, wherein a maximum value of a tan δ peak is 0.1 or more.

4. The polyimide film as set forth in claim 3, wherein the maximum value of the tan δ peak is 0.2 or less.

5. The polyimide film as set forth in claim 1, wherein an average linear expansion coefficient at 100 to 200° C. ranges from 5 to 20 ppm.

6. The polyimide film as set forth in claim 1, comprising a polyimide resin obtained by polymerizing acid dianhydride and diamine, wherein the diamine component includes 2,2-bis[4-(4-aminophenoxy)phenyl]propane.
